(19) United States
(12) Patent Application Publication
(10) Pub. No.: US 2025/0070279 A1
(43) Pub. Date: Feb. 27, 2025

(54) ELECTROCHEMICAL DEVICE AND BATTERY PACK CONTAINING SAME

(71) Applicant: Ningde Amperex Technology Limited, Ningde City (CN)

(72) Inventor: Liujun Huang, Ningde City (CN)

(73) Assignee: Ningde Amperex Technology Limited, Ningde City (CN)

(21) Appl. No.: 18/812,924

(22) Filed: Aug. 22, 2024

(30) Foreign Application Priority Data
Aug. 25, 2023 (CN) 202311082405.X

(51) Int. Cl. H01M 10/42; H01M 10/44; H01M 10/657; H01M 50/172; H01M 50/184; H01M 50/536; H01M 50/538

(52) U.S. Cl. CPC H01M 10/425; H01M 10/443; H01M 10/657; H01M 50/172; H01M 50/184; H01M 50/536; H01M 50/538

(57) ABSTRACT

An electrochemical device includes: a housing, a battery cell, a protection circuit module, a metal sheet, and at least two first conductive pieces. The battery cell is positioned in the housing. The first conductive pieces are electrically connected to the battery cell. Each first conductive piece includes a first portion. The first portion is a part of the first conductive piece and is exposed out of the housing. At least two first portions are electrically connected. At least one first portion is electrically connected to the metal sheet. The metal sheet is electrically connected to the protection circuit module. The electrochemical device and the battery pack containing the same effectively increase the charge rate and discharge rate, and well suppress the temperature rise during charging.

### CROSS-REFERENCE TO RELATED APPLICATION

This application claims priority to Chinese Patent Application No. 202311082405.X, filed on Aug. 25, 2023, the disclosure of which is hereby incorporated by reference in its entirety.

### TECHNICAL FIELD

This application relates to the technical field of electrochemistry, and in particular, to an electrochemical device and a battery pack containing same.

### BACKGROUND

With the wide application of fast-charge battery cells in diversified and complicated scenarios, the charge rate performance of battery cells is increasingly valued. A shorter charging time and improved user experience are particularly essential. At the same time, high-rate charging aggravates the temperature rise of battery cells, and even causes hazards such as spontaneous combustion. Therefore, how to alleviate the problem of rapid temperature rise during charging while increasing the charge rate becomes a pressing challenge to a person skilled in the art.

### SUMMARY

This application provides an electrochemical device and a battery pack containing same to increase the charge rate and discharge rate and reduce the temperature rise speed during charging.

To alleviate the above technical problem, according to a first aspect, this application provides an electrochemical device. The electrochemical device includes: a housing, a battery cell, a protection circuit module, a metal sheet, and at least two first conductive pieces. The battery cell is positioned in the housing. The first conductive pieces are electrically connected to the battery cell. Each first conductive piece includes a first portion. The first portion is a part of the first conductive piece and is exposed out of the housing. At least two first portions are electrically connected. At least one first portion is electrically connected to the metal sheet. The metal sheet is electrically connected to the protection circuit module.

In some embodiments, the electrochemical device further includes a sealing portion. Along a thickness direction of the electrochemical device, the first conductive piece further includes a second portion. The second portion is connected to the first portion. The protection circuit module, the metal sheet, the second portion, and the first portion are stacked up and disposed above the sealing portion.

In this embodiment, the first portion, the second portion, the metal sheet, and the protection circuit module included in the first conductive piece are all disposed above the sealing portion, the second portion is connected to the metal sheet, and the metal sheet is connected to the protection circuit module, thereby reducing the length of the first portion. In this way, the protection circuit module can be positioned above the sealing portion of the electrochemical device, thereby solving the problem that the protection circuit module is left away from the sealing portion due to the need for a sufficient welding length, and in turn, increasing the energy density of the battery containing the electrochemical device.

In some embodiments, a length of the first portion is less than a length of the second portion, and the length of the second portion is less than or equal to a sum of lengths of the first portion and the sealing portion.

In this embodiment, by defining the length of the second portion, the length of the second portion is less than or equal to the sum of the lengths of the first portion and the sealing portion, thereby avoiding the problem that the energy density of the battery containing the electrochemical device is reduced due to the excessive length of the second portion.

In some embodiments, the electrochemical device further includes at least two second conductive pieces. Each of the second conductive pieces includes a third portion. The third portion is a part of the second conductive piece and is exposed out of the housing. At least two third portions are electrically connected. At least one third portion is welded to the protection circuit module.

In this embodiment, the third portions of at least two second conductive pieces are connected together and then welded to the protection circuit module. The plurality of third portions connected together can improve the mechanical strength of the second conductive piece and improve the current conducting capacity of the second conductive piece.

In some embodiments, the second conductive piece further includes a fourth portion. The fourth portion is connected to the third portion. The protection circuit module, the third portion, and the fourth portion are stacked up and disposed above the sealing portion.

In this embodiment, the third portion, the fourth portion, and the protection circuit module included in the second conductive piece are all disposed above the sealing portion, and the fourth portion is connected to the protection circuit module, thereby reducing the length of the third portion. In this way, the protection circuit module can be positioned above the sealing portion of the electrochemical device, thereby solving the problem that the protection circuit module is left away from the sealing portion due to the need for a sufficient welding length, and in turn, increasing the energy density of the battery containing the electrochemical device.

In some embodiments, the first conductive piece further includes a fifth portion. The fifth portion is connected to the first portion and the electrode plate of the battery cell separately. The fifth portion and the first portion are formed in one piece.

In this embodiment, the fifth portion of the first conductive piece can connect the protection circuit module to the battery cell to implement charging and discharging of the battery cell.

In some embodiments, at least two first conductive pieces are connected to one battery cell, and the at least two first conductive pieces overlap or partially overlap along the thickness direction of the electrochemical device.

In this embodiment, a plurality of first conductive pieces are set to overlap or partially overlap, so that the plurality of first conductive pieces can be connected to the same position of the protection circuit module, thereby reducing weld joints and further increasing the mechanical strength of the first conductive pieces.

In some embodiments, at least two first conductive pieces are connected to different battery cells respectively. After the different battery cells are positioned into the housing, the at least two first conductive pieces overlap or partially overlap along the thickness direction of the electrochemical device.

In this embodiment, the first conductive pieces of different battery cells are connected to each other and then connected together to the protection circuit module. In addition, the plurality of first conductive pieces overlap or partially overlap, thereby reducing weld joints and also increasing the mechanical strength of the first conductive pieces.

In some embodiments, at least two first portions are connected by welding.

In this embodiment, the first portions of the plurality of first conductive pieces are connected by welding, thereby effectively ensuring high connection strength and a high current carrying capacity between the first conductive pieces.

In some embodiments, the second conductive piece further includes a sixth portion. The sixth portion is connected to the third portion and the electrode plate of the battery cell separately.

In this embodiment, the sixth portion of the second conductive piece can connect the protection circuit module to the battery cell to implement charging and discharging of the battery cell.

In some embodiments, at least two second conductive pieces are connected to one battery cell, and the at least two second conductive pieces overlap or partially overlap along the thickness direction of the electrochemical device.

In this embodiment, a plurality of second conductive pieces are set to overlap or partially overlap, so that the plurality of second conductive pieces can be connected to the same position of the protection circuit module, thereby reducing weld joints and further increasing the mechanical strength of the second conductive pieces.

In some embodiments, at least two second conductive pieces are connected to different battery cells respectively. After the different battery cells are positioned in the housing, the at least two second conductive pieces overlap or partially overlap along the thickness direction of the electrochemical device.

In this embodiment, the second conductive pieces of different battery cells are connected to each other and then connected together to the protection circuit module. In addition, the plurality of second conductive pieces overlap or partially overlap, thereby reducing weld joints and also increasing the mechanical strength of the second conductive pieces.

In some embodiments, at least two third portions are connected by welding.

In this embodiment, the third portions of the plurality of second conductive pieces are connected by welding, thereby effectively ensuring high connection strength and a high current carrying capacity between the second conductive pieces.

In some embodiments, only one of the first conductive pieces includes the second portion. This arrangement facilitates electrical connection between the conductive piece and the metal sheet.

According to a second aspect, this application provides a battery pack. The battery pack includes a plurality of electrochemical devices disclosed in any one of the above embodiments. The plurality of electrochemical devices are connected in series and/or in parallel.

In the electrochemical device of this application, at least two first conductive pieces are connected, one of the first conductive pieces is connected to a metal sheet, and the metal sheet is connected to a protection circuit module. On the one hand, this arrangement can shunt the current during charging and discharging of the battery cell, shortens the movement distance of electrons inside the battery cell, effectively increases the charge rate and discharge rate, reduces the charging internal resistance and the discharging internal resistance, and effectively suppresses the temperature rise during charging and discharging. On the other hand, this arrangement increases the mechanical strength of the first conductive pieces effectively.

### BRIEF DESCRIPTION OF DRAWINGS

The following describes features, advantages, and technical effects of exemplary embodiments of this application with reference to accompanying drawings.

FIG. 1 is a cross-sectional schematic view of an electrochemical device according to an embodiment of this application;

FIG. 2 is a cross-sectional schematic view of an electrochemical device according to another embodiment of this application;

FIG. 3 is a schematic diagram of a position of connection from a first conductive piece and a second conductive piece on a battery cell to the battery cell according to a first embodiment of this application;

FIG. 4 is a schematic diagram of a position of connection from a first conductive piece and a second conductive piece on a battery cell to the battery cell according to a second embodiment of this application;

FIG. 5 is a schematic diagram of a position of connection from a first conductive piece and a second conductive piece on a battery cell to the battery cell according to a third embodiment of this application;

FIG. 6 is a schematic diagram of a position of connection from a first conductive piece and a second conductive piece on a battery cell to the battery cell according to a fourth embodiment of this application;

FIG. 7 is a schematic diagram of a position of connection from a first conductive piece and a second conductive piece on a battery cell to the battery cell according to a fifth embodiment of this application;

FIG. 8 is a schematic diagram of a position of connection from a first conductive piece and a second conductive piece on a battery cell to the battery cell according to a sixth embodiment of this application;

FIG. 9 is a schematic diagram of a position of connection from a first conductive piece and a second conductive piece on a battery cell to the battery cell according to a seventh embodiment of this application;

FIG. 10 is a schematic diagram of a position of connection from a first conductive piece and a second conductive piece on a battery cell to the battery cell according to an eighth embodiment of this application; and

FIG. 11 is a schematic diagram of a position of connection from a first conductive piece and a second conductive piece on a battery cell to the battery cell according to a ninth embodiment of this application.

### LIST OF REFERENCE NUMERALS

1. housing
2. battery cell
3. protection circuit module
4. metal sheet
5. first conductive piece
50. positive tab
51. first portion
52. second portion
6. second conductive piece
60. negative tab
61. third portion
62. fourth portion
7. sealing portion

### DETAILED DESCRIPTION OF EMBODIMENTS

To make the objectives, technical solutions, and advantages of this application clearer, the following describes the embodiments of technical solutions of this application in detail with reference to accompanying drawings. Evidently, the described embodiments are merely a part of but not all of the embodiments of the present invention. The following embodiments are merely intended as examples to describe the technical solutions of this application, but not intended to limit the protection scope of this application. A person skilled in the art understands that, to the extent that no conflict occurs, the following embodiments and the features in the embodiments may be combined with each other.

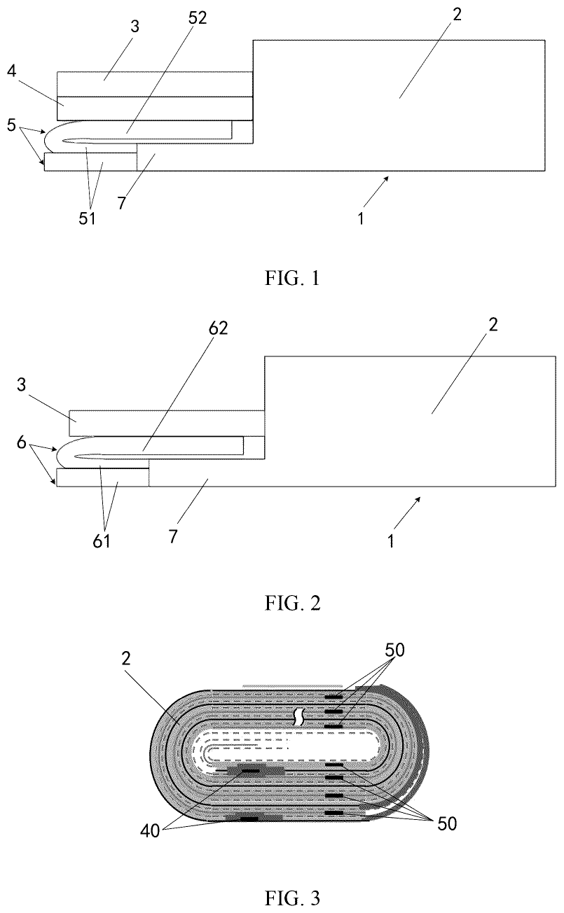

Referring to FIG. 1, an embodiment of this application provides an electrochemical device. The electrochemical device includes: a housing 1, a battery cell 2, a protection circuit module 3, a metal sheet 4, and at least two first conductive pieces 5.

The battery cell 2 is positioned in the housing 1. The first conductive pieces 5 are electrically connected to the battery cell 2. Each first conductive piece 5 includes a first portion 51. The first portion 51 is a part of the first conductive piece 5 and is exposed out of the housing 1. At least two first portions 51 are electrically connected. At least one first portion 51 is electrically connected to the metal sheet 4. The metal sheet 4 is electrically connected to the protection circuit module 3.

Optionally, the protection circuit module 3 is a PCB board, and is configured to control the charging and discharging of the battery cell 2.

In this application, at least two first conductive pieces 5 are exposed out of the first portion 51 of the housing 1 and are electrically connected, and at least one first portion 51 of at least two first conductive pieces 5 is connected to the metal sheet 4. The metal sheet 4 is electrically connected to the protection circuit module 3. In this way, the current is shunted by at least two first conductive pieces 5 during charging and discharging, thereby shortening the movement distance of electrons inside the battery cell 2, and effectively improving the charge rate and the discharge rate. In addition, due to the shortened movement distance of the electrons inside the battery cell 2, the internal resistance of the battery cell 2 is reduced during charging and discharging, thereby effectively suppressing the temperature rise during the charging and discharging. Furthermore, by connecting the first portions 51 of at least two first conductive pieces 5, this application effectively increases the mechanical strength of the first conductive pieces 5.

Optionally, the first conductive pieces 5 are positive tabs 50 of the electrochemical device.

It is known that the material at the weld point on the protection circuit module 3 is usually copper, and the positive tab 50 of the battery cell 2 is usually made of aluminum. In order to ensure firm welding between the first conductive piece 5 and the protection circuit module 3, this application provides a metal sheet 4 for interconnection. To be specific, the first portion 51 of the first conductive piece 5 is electrically connected to the metal sheet 4, and the metal sheet 4 is electrically connected to the protection circuit module 3.

Optionally, the metal sheet 4 is a nickel sheet.

In an embodiment, the first portions 51 of at least two first conductive pieces 5 are connected by welding, so as to ensure high connection strength and a high current carrying capacity between the first conductive pieces 5.

In an embodiment, the first conductive piece 5 further includes a fifth portion (not shown in the drawing). The fifth portion is connected to the first portion 51 of the first conductive piece 5 and the battery cell 2 separately.

In this embodiment, the fifth portion of the first conductive piece 5 connects the first portion 51 of the first conductive piece 5 to the battery cell 2, so as to connect the protection circuit module 3 to the battery cell 2.

Optionally, the first portion 51 and the fifth portion of the first conductive piece 5 may be formed in one piece, or may be connected by welding.

In an embodiment, at least two first conductive pieces 5 are connected to the same battery cell 2, and the at least two first conductive pieces 5 overlap or partially overlap along the thickness direction of the electrochemical device.

In this embodiment, at least two first conductive pieces 5 are disposed on one battery cell 2. After at least two battery cells 2 are put into the housing 1 and after the at least two first conductive pieces 5 are electrically connected, the first portion 51 of one of the at least two first conductive pieces 5 is connected to the metal sheet 4, and the metal sheet 4 is connected to the protection circuit module 3, so as to form a parallel connection between the at least two first conductive pieces 5. During charging and discharging, the at least two first conductive pieces 5 transmit the current at the same time, thereby shortening the movement distance of electrons in the battery cell 2, increasing the charge rate and the discharge rate, reducing the internal resistance of the battery cell 2 during charging and discharging, and effectively suppressing the temperature rise during charging and discharging.

In this embodiment, the thickness of the electrochemical device means a thickness of a multi-layer structure formed by the positive electrode plate, the separator, and the negative electrode plate in the battery cell 2.

It is hereby noted that the overlap described in this embodiment is a theoretical overlap. Even with misalignment between the at least two first conductive pieces 5 caused by a processing process or other reasons, the overlap is still deemed an overlap between the at least two first conductive pieces 5.

In this embodiment, at least two first conductive pieces 5 are set to overlap or partially overlap, thereby effectively reducing the weld joints formed in connecting the at least two first conductive pieces 5, and in turn, shortening the process time and improving production efficiency. In addition, setting the at least two first conductive pieces 5 to overlap or partially overlap can also increase the mechanical strength of the first conductive pieces 5 and ensure stability of the electrochemical device in use.

In another embodiment, at least two first conductive pieces 5 are connected to different battery cells 2 respectively. After the different battery cells 2 are placed into the housing 1, the at least two first conductive pieces 5 overlap or partially overlap along the thickness direction of the electrochemical device.

In this embodiment, at least two first conductive pieces 5 are connected to different battery cells 2 respectively. After at least two battery cells 2 are put into the housing 1 and after the at least two first conductive pieces 5 are connected, the first portion 51 of one of the at least two first conductive pieces 5 is connected to the metal sheet 4, and the metal sheet 4 is connected to the protection circuit module 3, so as to form a parallel connection between the at least two first conductive pieces 5.

In this embodiment, the thickness of the electrochemical device means a thickness of a stacked structure formed by at least two battery cells 2 placed in the housing 1.

It is hereby noted that the overlap described in this embodiment is a theoretical overlap. Even with misalignment between the at least two first conductive pieces 5 caused by a processing process or other reasons, the overlap is still deemed an overlap between the at least two first conductive pieces 5.

In this embodiment, at least two first conductive pieces 5 are set to overlap or partially overlap, thereby effectively reducing the weld joints formed in connecting the at least two first conductive pieces 5, and in turn, shortening the process time and improving production efficiency. In addition, setting the at least two first conductive pieces 5 to overlap or partially overlap can also increase the mechanical strength of the first conductive pieces 5 and ensure stability of the electrochemical device in use.

In an embodiment, the electrochemical device further includes a sealing portion 7. Along a thickness direction of the electrochemical device, the first conductive piece 5 further includes a second portion 52. The second portion 52 is connected to the first portion 51 of the first conductive piece 5. The protection circuit module 3, the second portion 52, and the first portion 51 are stacked up and disposed above the sealing portion 7.

In this embodiment, the thickness of the electrochemical device is a thickness of a multi-layer structure formed by the positive electrode plate, the separator, and the negative electrode plate in the battery cell 2, or a thickness of a stacked structure formed by at least two battery cells 2 placed in the housing 1.

The second portion 52 of the first conductive piece 5 and the first portion 51 of the first conductive piece 5 may be formed in one piece, and then folded back toward the battery cell 2 and positioned above the sealing portion 7. Alternatively, the second portion 52 may be placed above the sealing portion 7 and then connected to the first portion 51 by welding.

In an embodiment, as shown in FIG. 1, only one first conductive piece 5 includes a second portion 52. The second portion 52 is connected to an end, away from the battery cell 2, of the first portion 51, and then is folded back toward the protection circuit module 3, and extends toward the battery cell 2. Finally, the electrical connection between the protection circuit module 3 and the battery cell 2 is implemented through the welding between the second portion 52 and the protection circuit module 3. Through this structure, the connection between a plurality of first conductive pieces 5 is implemented by the connection between the first portions 51, and the connection from the plurality of first conductive pieces 5 to the protection circuit module 3 is implemented through the connection between the second portion 52 and the protection circuit module 3. In addition, the extension length of the first conductive piece 5 extending away from the battery cell 2 is reduced by folding back the second portion 52, thereby reducing the volume of the electrochemical device, improving the space utilization of the electrochemical device, and increasing the energy density of the battery.

In an embodiment, as shown in FIG. 1, a length of the first portion 51 of the first conductive piece 5 is less than a length of the second portion 52, and the length of the second portion 52 is less than or equal to a sum of lengths of the first portion 51 and the sealing portion 7.

In this embodiment, the length of the first portion 51 of the first conductive piece 5 is controlled to be less than the length of the second portion 52, thereby reducing the extension length of the first portion 51 of the first conductive piece 5 extending away from the battery cell 2. In addition, the length of the second portion 52 of the first conductive piece 5 is controlled to be less than or equal to the sum of the lengths of the first portion 51 and the sealing portion 7, thereby preventing the volume of the electrochemical device from being increased by an excessive extension length of the second portion 52, and in turn, increasing the energy density of the battery containing the electrochemical device.

To enable the electrochemical device to form a circuit during charging and discharging, as shown in FIG. 2, the electrochemical device further includes a second conductive piece 6.

In an embodiment, the number of second conductive pieces 6 is one, and two ends of the second conductive piece are connected to the battery cell 2 and the protection circuit module 3, respectively.

In another embodiment, as shown in FIG. 2, the number of second conductive pieces 6 is at least two. Each of the second conductive pieces 6 includes a third portion 61. The third portion 61 is a part of the second conductive piece 6 and is exposed out of the housing 1. At least two third portions 61 are electrically connected. At least one third portion 61 is welded to the protection circuit module 3.

This application can effectively increase the mechanical strength of the second conductive pieces 6 by electrically connecting the third portions 61, exposed out of the housing 1, of at least two second conductive pieces 6, and by welding one third portion 61 of the at least two second conductive pieces 6 to the protection circuit module 3.

Optionally, the second conductive pieces 6 are negative tabs 60 of the electrochemical device.

In an embodiment, the third portions 61 of at least two second conductive pieces 6 are connected by welding, so as to ensure high connection strength and a high current carrying capacity between the second conductive pieces 6.

In an embodiment, the second conductive piece 6 further includes a sixth portion (not shown in the drawing). The sixth portion is connected to the third portion 61 of the second conductive piece 6 and the battery cell 2 separately.

In this embodiment, the sixth portion of the second conductive piece 6 connects the third portion 61 of the second conductive piece 6 to the battery cell 2, so as to connect the protection circuit module 3 to the battery cell 2.

Optionally, the third portion 61 and the sixth portion of the second conductive piece 6 may be formed in one piece, or may be connected by welding.

In an embodiment, along the thickness direction of the electrochemical device, the second conductive piece 6 further includes a fourth portion 62. The fourth portion 62 is connected to the third portion 61. The protection circuit module 3, the third portion 61, and the fourth portion 62 are stacked up and disposed above the sealing portion 7.

In this embodiment, the thickness of the electrochemical device is a thickness of a multi-layer structure formed by the positive electrode plate, the separator, and the negative electrode plate in the battery cell 2, or a thickness of a stacked structure formed by at least two battery cells 2 placed in the housing 1.

The fourth portion 62 of the second conductive piece 6 and the third portion 61 of the second conductive piece 6 may be formed in one piece, and then folded back toward the battery cell 2 and positioned above the sealing portion 7. Alternatively, the fourth portion 62 may be placed above the sealing portion 7 by welding or other means and then connected to the third portion 61 by welding.

In an embodiment, as shown in FIG. 2, the fourth portion 62 is connected to an end, away from the battery cell 2, of the third portion 61, and then is folded back toward the protection circuit module 3, and extends toward the battery cell 2. Finally, the electrical connection between the protection circuit module 3 and the battery cell 2 is implemented through the welding between the fourth portion 62 and the protection circuit module 3. Through this structure, the connection between a plurality of second conductive pieces 6 is implemented by the connection between the third portions 61, and the connection from the plurality of second conductive pieces 6 to the protection circuit module 3 is implemented through the connection between the fourth portion 62 and the protection circuit module 3. In addition, the extension length of the second conductive piece 6 extending away from the battery cell 2 is reduced by folding back the fourth portion 62, thereby reducing the volume of the electrochemical device, improving the space utilization of the electrochemical device, and increasing the energy density of the battery.

In an embodiment, as shown in FIG. 2, a length of the third portion 61 of the second conductive piece 6 is less than a length of the fourth portion 62, and the length of the fourth portion 62 is less than or equal to a sum of lengths of the third portion 61 and the sealing portion 7.

In this embodiment, the length of the third portion 61 of the second conductive piece 6 is controlled to be less than the length of the fourth portion 62, thereby reducing the extension length of the third portion 61 of the second conductive piece 6 extending away from the battery cell 2. In addition, the length of the fourth portion 62 of the second conductive piece 6 is controlled to be less than or equal to the sum of the lengths of the third portion 61 and the sealing portion 7, thereby preventing the volume of the electrochemical device from being increased by an excessive extension length of the fourth portion 62, and in turn, increasing the energy density of the battery containing the electrochemical device.

In an embodiment, at least two second conductive pieces 6 are connected to the same battery cell 2, and the at least two second conductive pieces 6 overlap or partially overlap along the thickness direction of the electrochemical device.

In this embodiment, the thickness of the electrochemical device means a thickness of a multi-layer structure formed by the positive electrode plate, the separator, and the negative electrode plate in the battery cell 2.

It is hereby noted that the overlap described in this embodiment is a theoretical overlap. Even with misalignment between the at least two second conductive pieces 6 caused by a processing process or other reasons, the overlap is still deemed an overlap between the at least two second conductive pieces 6.

In this embodiment, at least two second conductive pieces 6 are set to overlap or partially overlap, thereby effectively reducing the weld joints formed in connecting the at least two second conductive pieces 6, and in turn, shortening the process time and improving production efficiency. In addition, setting the at least two second conductive pieces 6 to overlap or partially overlap can also increase the mechanical strength of the second conductive pieces 6 and ensure stability of the electrochemical device in use.

In another embodiment, at least two second conductive pieces 6 are connected to different battery cells 2 respectively. After the different battery cells 2 are placed into the housing 1, the at least two second conductive pieces 6 overlap or partially overlap along the thickness direction of the electrochemical device.

In this embodiment, at least two second conductive pieces 6 are connected to different battery cells 2 respectively. After at least two battery cells 2 are put into the housing 1 and after the at least two second conductive pieces 6 are connected, the third portion 61 of one of the at least two second conductive pieces 6 is connected to the protection circuit module 3, so as to form a parallel connection between the at least two second conductive pieces 6.

In this embodiment, the thickness of the electrochemical device means a thickness of a stacked structure formed by at least two battery cells 2 placed in the housing 1.

It is hereby noted that the overlap described in this embodiment is a theoretical overlap. Even with misalignment between the at least two second conductive pieces 6 caused by a processing process or other reasons, the overlap is still deemed an overlap between the at least two second conductive pieces 6.

In this embodiment, at least two second conductive pieces 6 are set to overlap or partially overlap, thereby effectively reducing the weld joints formed in connecting the at least two second conductive pieces 6, and in turn, shortening the process time and improving production efficiency. In addition, setting the at least two second conductive pieces 6 to overlap or partially overlap can also increase the mechanical strength of the second conductive pieces 6 and ensure stability of the electrochemical device in use.

In some specific embodiments, the first conductive piece 5 is a positive tab 50, the second conductive piece 6 is a negative tab 60, and the battery cell 2 is a jelly-roll battery cell 2. The number of positive tabs 50 is two, and the number of negative tabs 60 is two. The positive tabs 50 and the negative tabs 60 may be arranged in different positions, as described in the following embodiments.

In some specific embodiments, only one of the first conductive pieces 5 includes a second portion 52. This arrangement facilitates electrical connection between the conductive piece and the metal sheet, and can reduce the loss of the energy density of the battery.

### Embodiment 1

Two positive tabs 50 are welded to the positive electrode plate at a ¼ point and a ¾ point, respectively, of the length of the double-side-coated region of the positive electrode plate. Two negative tabs 60 are welded to the negative electrode plate at a ¼ point and a ¾ point, respectively, of the length of the double-side-coated region of the negative electrode plate.

### Embodiment 2

Two positive tabs 50 are welded to the positive electrode plate at a ¼ point and a ¾ point, respectively, of the length of the double-side-coated region of the positive electrode plate. Two negative tabs 60 are welded to the negative electrode plate at the starting blank foil region of the negative electrode plate and a ¾ point of the length of the double-side-coated region of the negative electrode plate, respectively.

### Embodiment 3

Two positive tabs 50 are welded to the positive electrode plate at a ¼ point and a ¾ point, respectively, of the length of the double-side-coated region of the positive electrode plate. Two negative tabs 60 are welded to the negative electrode plate at the starting single-side-coated region of the negative electrode plate and a ¾ point of the length of the double-side-coated region of the negative electrode plate, respectively.

### Embodiment 4

Two positive tabs 50 are welded to the positive electrode plate at a ¼ point of the length of the double-side-coated region of the positive electrode plate and at a terminating single-side-coated region of the positive electrode plate, respectively. Two negative tabs 60 are welded to the negative electrode plate at a ¼ point and a ¾ point, respectively, of the length of the double-side-coated region of the negative electrode plate.

### Embodiment 5

Two positive tabs 50 are welded to the positive electrode plate at a ¼ point of the length of the double-side-coated region of the positive electrode plate and at the terminating single-side-coated region of the positive electrode plate, respectively. Two negative tabs 60 are welded to the negative electrode plate at the starting blank foil region of the negative electrode plate and at a ¾ point of the length of the double-side-coated region of the negative electrode plate, respectively.

### Embodiment 6

Two positive tabs 50 are welded to the positive electrode plate at a ¼ point of the length of the double-side-coated region of the positive electrode plate and at the terminating single-side-coated region of the positive electrode plate, respectively. Two negative tabs 60 are welded to the negative electrode plate at the starting single-side-coated region of the negative electrode plate and at a ¾ point of the length of the double-side-coated region of the negative electrode plate, respectively.

### Comparative Embodiment

The positive tab 50 is welded to the positive electrode plate at the center of the length of the positive electrode plate, and the negative tab 60 is welded to the negative electrode plate at the center of the length of the negative electrode plate.

The open-circuit voltage (OCV), resistance, and temperature rise are tested and the charging time data is collected for the battery cells prepared in different embodiments and comparative embodiments. The test results are shown in the following table.

Table 1 shows the test results of the voltage and resistance of the battery cells 2 in Embodiments 1 to 6 and the comparative embodiment.

TABLE 1

| Group | OCV (V) | Resistance (mΩ) |
|---|---|---|
| Embodiment 1 | 3.834 | 7.94 |
| Embodiment 2 | 3.833 | 9.56 |
| Embodiment 3 | 3.833 | 10.58 |
| Embodiment 4 | 3.834 | 8.22 |
| Embodiment 5 | 3.833 | 10.03 |
| Embodiment 6 | 3.833 | 10.88 |
| Comparative | 3.833 | 11.83 |
| Embodiment | | |

Table 2 shows the test results of the charging time and the temperature increment of the battery cells 2 charged at a 3C charge rate and prepared in Embodiments 1 to 6 and the comparative embodiment.

TABLE 2

| | Constant | Constant | Temperature |
|---|---|---|---|
| | voltage | current + constant | increment |
| Group | (min) | voltage (min) | (° C.) |
| Embodiment 1 | 29.03 | 44.59 | 37.85 |
| Embodiment 2 | 36.48 | 50.26 | 38.24 |
| Embodiment 3 | 39.12 | 52.38 | 39.23 |
| Embodiment 4 | 32.03 | 46.71 | 38.03 |
| Embodiment 5 | 37.79 | 51.33 | 38.66 |
| Embodiment 6 | 39.34 | 52.56 | 39.52 |
| Comparative | 40.37 | 53.42 | 39.90 |
| Embodiment | | | |

Table 3 shows the test results of the charging time and the temperature increment of the battery cells 2 charged at a 4C charge rate and prepared in Embodiments 1 to 6 and the comparative embodiment.

TABLE 3

| | Constant | Constant | Temperature |
|---|---|---|---|
| | voltage | current + constant | increment |
| Group | (min) | voltage (min) | (° C.) |
| Embodiment 1 | 27.95 | 38.89 | 43.88 |
| Embodiment 2 | 35.28 | 45.06 | 44.55 |
| Embodiment 3 | 37.82 | 47.08 | 45.26 |
| Embodiment 4 | 30.03 | 40.71 | 44.18 |
| Embodiment 5 | 36.59 | 46.13 | 44.89 |
| Embodiment 6 | 38.04 | 47.26 | 45.92 |
| Comparative | 41.59 | 49.37 | 46.45 |
| Embodiment | | | |

Table 4 shows the test results of the charging time and the temperature increment of the battery cells 2 charged at a 5C charge rate and prepared in Embodiments 1 to 6 and the comparative embodiment.

TABLE 4

| | Constant | Constant | Temperature |
|---|---|---|---|
| | voltage | current + constant | increment |
| Group | (min) | voltage (min) | (° C.) |
| Embodiment 1 | 27.21 | 35.38 | 49.53 |
| Embodiment 2 | 34.98 | 41.26 | 50.24 |
| Embodiment 3 | 37.62 | 43.38 | 51.23 |
| Embodiment 4 | 30.53 | 37.71 | 50.03 |
| Embodiment 5 | 36.29 | 42.33 | 50.66 |
| Embodiment 6 | 37.84 | 43.56 | 51.52 |
| Comparative | 44.01 | 47.79 | 52.40 |
| Embodiment | | | |

As can be seen from the test results of the battery cells 2 in terms of the resistance of the battery cell as well as the full-charge time and charging temperature increment of the battery cell charged at different rates, the exemplary embodiments of this application are of great help in shortening the charging time and reducing the charging temperature increment, and are of great use value in improving the safety of the battery cell 2 in use.

In some other specific embodiments, the first conductive piece 5 is a positive tab 50, the second conductive piece 6 is a negative tab 60, and the battery cell 2 is a jelly-roll battery cell 2. The number of positive tabs 50 is two, and the number of negative tabs 60 is one or more. After completion of winding the battery cell 2, the positive tab 50 and the negative tab 60 can overlap or partially overlap along the thickness direction of the electrochemical device. The positive tabs 50 and the negative tabs 60 may be arranged in different positions, as described in the following embodiments.

### Embodiment 7

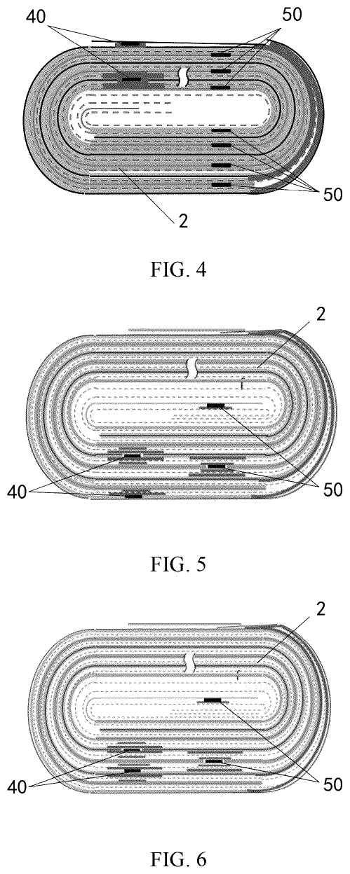

In this embodiment, the number of positive tabs 50 is two, and the number of negative tabs 60 is plural. One positive tab 50 is connected to the positive electrode plate at a 25% to 50% point of the length of the positive electrode plate, another positive tab 50 is connected to the positive electrode plate at the terminating single-side-coated region (as shown in FIG. 3) of the positive electrode plate or the starting single-side-coated region (as shown in FIG. 4) of the positive electrode plate. A plurality of negative tabs 60 are connected to the negative electrode plate. After completion of winding, the two positive tabs 50 overlap or partially overlap along the thickness direction of the battery cell 2, and the plurality of negative tabs 60 overlap or partially overlap along the thickness direction of the battery cell 2.

### Embodiment 8

In this embodiment, as shown in FIG. 5, the number of positive tabs 50 is two, and the number of negative tabs 60 is two. One positive tab 50 is connected to the positive electrode plate at a ¼ point of the length of the double-side-coated region of the positive electrode plate, another positive tab 50 is connected to the terminating single-side-coated region of the positive electrode plate. One negative tab 60 is connected to the starting blank foil region of the negative electrode plate, and another negative tab 60 is connected to the negative electrode plate at an unspecified position, preferably, at a ½ point of the length of the double-side-coated region of the negative electrode plate. After completion of winding, the two positive tabs 50 overlap or partially overlap along the thickness direction of the battery cell 2, and the two negative tabs 60 overlap or partially overlap along the thickness direction of the battery cell 2.

Alternatively, as shown in FIG. 6, one positive tab 50 is connected to the positive electrode plate at a ¼ point of the length of the double-side-coated region of the positive electrode plate, and another positive tab 50 is connected to the positive electrode plate at a ¾ point of the length of the double-side-coated region of the positive electrode plate. One negative tab 60 is connected to the starting blank foil region of the negative electrode plate, and another negative tab 60 is connected to the negative electrode plate at an unspecified position, preferably at a ½ point of the length of the double-side-coated region of the negative electrode plate. After completion of winding, the two positive tabs 50 overlap or partially overlap along the thickness direction of the battery cell 2, and the two negative tabs 60 overlap or partially overlap along the thickness direction of the battery cell 2.

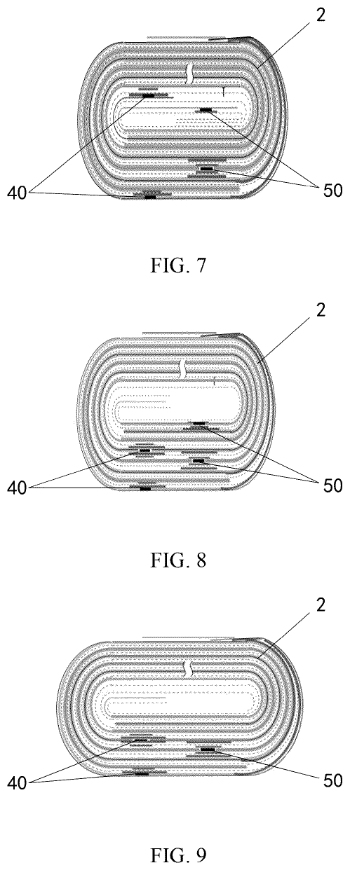

Alternatively, as shown in FIG. 7, one positive tab 50 is connected to the starting blank foil region of the positive electrode plate, and another positive tab 50 is connected to the terminating single-side-coated region of the positive electrode plate. One negative tab 60 is connected to the starting blank foil region of the negative electrode plate, and another negative tab 60 is connected to the negative electrode plate at an unspecified position, preferably, at a ½ point of the length of the double-side-coated region of the negative electrode plate. After completion of winding, the two positive tabs 50 overlap or partially overlap along the thickness direction of the battery cell 2, and the two negative tabs 60 overlap or partially overlap along the thickness direction of the battery cell 2.

Alternatively, as shown in FIG. 8, one positive tab 50 is connected to the positive electrode plate at a ¼ point of the length of the double-side-coated region of the positive electrode plate, and another positive tab 50 is connected to the terminating single-side-coated region of the positive electrode plate. One negative tab 60 is connected to the starting blank foil region of the negative electrode plate, and another negative tab 60 is connected to the negative electrode plate at an unspecified position, preferably, at a ½ point of the length of the double-side-coated region of the negative electrode plate. After completion of winding, the two positive tabs 50 overlap or partially overlap along the thickness direction of the battery cell 2, and the two negative tabs 60 overlap or partially overlap along the thickness direction of the battery cell 2.

### Embodiment 9

In this embodiment, the number of positive tabs 50 is two, and the number of negative tabs 60 is one. As shown in FIG. 9, one positive tab 50 is connected to the positive electrode plate at a 10% to 60% point of the length of the positive electrode plate, and another positive tab 50 is connected to the terminating single-side-coated region of the positive electrode plate. The negative tab 60 is connected to the negative electrode plate at an unspecified position, preferably, at a ½ point of the length of the double-side-coated region of the negative electrode plate. After completion of winding, the two positive tabs 50 overlap or partially overlap along the thickness direction of the battery cell 2.

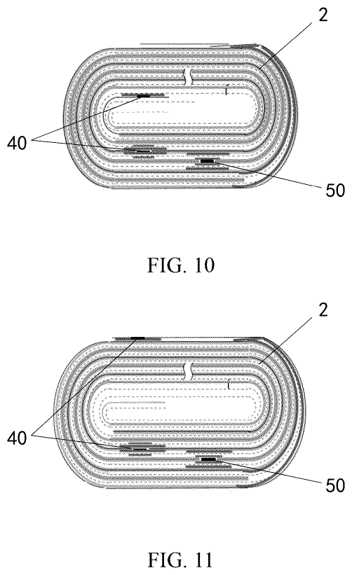

Alternatively, as shown in FIG. 10, one positive tab 50 is connected to the positive electrode plate at a 10% to 60% point of the length of the positive electrode plate, and another positive tab 50 is connected to the starting blank foil region of the positive electrode plate. The negative tab 60 is connected to the negative electrode plate at an unspecified position, preferably, at a ½ point of the length of the double-side-coated region of the negative electrode plate. After completion of winding, the two positive tabs 50 overlap or partially overlap along the thickness direction of the battery cell 2.

Alternatively, as shown in FIG. 11, one positive tab 50 is connected to the positive electrode plate at a 10% to 60% point of the length of the positive electrode plate, and another positive tab 50 is connected to the terminating blank foil region of the positive electrode plate. The negative tab 60 is connected to the negative electrode plate at an unspecified position, preferably, at a ½ point of the length of the double-side-coated region of the negative electrode plate. After completion of winding, the two positive tabs 50 overlap or partially overlap along the thickness direction of the battery cell 2.

This application provides a battery pack. The battery pack includes a plurality of electrochemical devices disclosed in any one of the above embodiments. The plurality of electrochemical devices in the battery pack are connected in series and/or in parallel.

Described above are merely exemplary embodiments of this application rather than any limitations on this application. Although this application has been disclosed above with reference to exemplary embodiments, the exemplary embodiments are not intended to limit this application. Any modifications or refinements, which may be made by a person skilled in the art by taking advantage of the foregoing technical content without departing from the scope of the technical solutions hereof, are equivalent embodiments of this application. Any simple modifications, equivalent changes, and refinements made to the above embodiments based on the technical essence of this application without departing from the subject-matter of the technical solutions hereof still fall within the scope of the technical solutions of this application.

What is claimed is:

1. An electrochemical device, comprising: a housing, a battery cell, a protection circuit module, a metal sheet, and at least two first conductive pieces; wherein,
the battery cell is disposed in the housing, the at least two first conductive pieces are electrically connected to the battery cell, each first conductive piece comprises a first portion, the first portion is exposed out of the housing, the first portions of the at least two first conductive pieces are electrically connected to each other, at least one first portion is electrically connected to the metal sheet, and the metal sheet is electrically connected to the protection circuit module.

2. The electrochemical device according to claim 1, further comprising a sealing portion; along a thickness direction of the electrochemical device, at least one of the at least two first conductive pieces further comprises a second portion, the second portion is connected to the first portion; and the protection circuit module, the metal sheet, the second portion, and the first portion are stacked up and disposed above the sealing portion.

3. The electrochemical device according to claim 2, wherein a length of the first portion is less than a length of the second portion, and the length of the second portion is less than or equal to a sum of the length of the first portion and a length of the sealing portion.

4. The electrochemical device according to claim 1, further comprising at least two second conductive pieces; and
each of the second conductive pieces comprises a third portion, the third portion is exposed out of the housing, the at least two third portions are electrically connected to each other, and at least one third portion is welded to the protection circuit module.

5. The electrochemical device according to claim 4, wherein, along a thickness direction of the electrochemical device, the each second conductive piece further comprises a fourth portion, the fourth portion is connected to the third portion; and the protection circuit module, the third portion, and the fourth portion are stacked up and disposed above the sealing portion.

6. The electrochemical device according to claim 1, wherein, the at least two first conductive pieces are connected to one battery cell; and
the at least two first conductive pieces at least partially overlap with each other along a thickness direction of the electrochemical device.

7. The electrochemical device according to claim 1, wherein, the at least two first conductive pieces are connected to different battery cells respectively; the different battery cells are disposed in the housing; and the at least two first conductive pieces at least partially overlap with each other along a thickness direction of the electrochemical device.

8. The electrochemical device according to claim 1, wherein, the first portions of the at least two first conductive pieces are connected to each other by welding.

9. The electrochemical device according to claim 2, wherein, only one of the at least two first conductive pieces comprises the second portion.

10. The electrochemical device according to claim 4, wherein, the at least two second conductive pieces are connected to one battery cell; and the at least two second conductive pieces at least partially overlap along a thickness direction of the electrochemical device.

11. The electrochemical device according to claim 4, wherein, the at least two second conductive pieces are connected to different battery cells respectively; the different battery cells are disposed in the housing; and the at least two second conductive pieces at least partially overlap with each other along a thickness direction of the electrochemical device.

12. The electrochemical device according to claim 4, wherein, the third portions of the at least two second conductive pieces are connected by welding.

13. The electrochemical device according to claim 1, wherein, the at least two first conductive pieces are connected to the one battery cell; and
the at least two first conductive pieces at least partially overlap with each other along the thickness direction of the electrochemical device.

14. The electrochemical device according to claim 1, wherein, the at least two first conductive pieces are connected to the different battery cells respectively; and the at least two first conductive pieces at least partially overlap with each other along the thickness direction of the electrochemical device.

15. The electrochemical device according to claim 12, wherein, the first portions of the at least two first conductive pieces are connected to each other by welding.

16. A battery pack, comprising a plurality of electrochemical devices; wherein each electrochemical device is the electrochemical device according to claim 1; and the plurality of electrochemical devices are connected in series and/or in parallel.

17. The battery pack according to claim 16, further comprising a sealing portion; along a thickness direction of the electrochemical device, at least one of the at least two first conductive pieces further comprises a second portion, the second portion is connected to the first portion; and the protection circuit module, the metal sheet, the second portion, and the first portion are stacked up and disposed above the sealing portion.

18. The battery pack according to claim 17, wherein a length of the first portion is less than a length of the second portion, and the length of the second portion is less than or equal to a sum of the length of the first portion and a length of the sealing portion.

19. The battery pack according to claim 16, further comprising at least two second conductive pieces; and
each of the second conductive pieces comprises a third portion, the third portion is exposed out of the housing, the at least two third portions are electrically connected to each other, and at least one third portion is welded to the protection circuit module.

20. The battery pack according to claim 19, wherein, along a thickness direction of the electrochemical device, the each second conductive piece further comprises a fourth portion, the fourth portion is connected to the third portion; and the protection circuit module, the third portion, and the fourth portion are stacked up and disposed above the sealing portion.
